(19) United States
(12) Patent Application Publication
(10) Pub. No.: US 2004/0259516 A1
(43) Pub. Date: Dec. 23, 2004

(54) Apparatus and method of controlling a low noise amplifier of a receiver

(76) Inventors: Tae-don Hwang, Suwon-si (KR); Jeong-shan Na, Suwon-si (KR)

Correspondence Address: STANZIONE & KIM, LLP, 1740 N STREET, N.W., FIRST FLOOR, WASHINGTON, DC, 20036, US

(21) Appl. No.: 10/842,452

(22) Filed: May 11, 2004

(30) Foreign Application Priority Data
Jun. 17, 2003 (KR) 2003-39121

(51) Int. Cl. H04B 1/26; H04B 7/00

(52) U.S. Cl. 455/234.1; 455/323; 455/200.1

(57) ABSTRACT

An apparatus and a method of controlling a low noise amplifier of a receiver, in which the activation of the low noise amplifier is automatically controlled using an automatic gain control current for a received signal. The apparatus may include a low noise amplifier, an automatic gain control current detector, a switch, and a controller. The low noise amplifier amplifies a noise-free received signal. The automatic gain control current detector detects an automatic gain control current based on the level of a signal output from the low noise amplifier. The switch controls the activation of the low noise amplifier. The controller controls the operation of the switch according to the automatic gain control current detected by the automatic gain control current detector.

### CROSS-REFERENCE TO RELATED APPLICATIONS

This application claims the priority of Korean Patent Application No. 2003-39121, filed on Jun. 17, 2003, in the Korean Intellectual Property Office, the disclosure of which is incorporated herein in its entirety by reference.

### BACKGROUND OF THE INVENTION

1. Field of the Invention

The present invention relates to control of a low noise amplifier (hereinafter, referred to as a LNA) of a receiver, and more particularly, to an apparatus and method of controlling an LNA of a receiver so that the receiver can keep an excellent receive sensitivity.

2. Description of the Related Art

LNAs remove noise from a received signal and amplify the noise-free received signal. If an electric field of the received signal is weak, the LNA enables a receiver to keep a good receive sensitivity. However, an electric field intensity of the received signal may have a strong electric field.

Accordingly, in order to keep a good receive sensitivity no matter what a received signal has with respect to either a weak or strong electric field, a conventional receiver with an LNA controls the gain of the LNA according to the electric field intensity of the received signal using an automatic gain control (hereinafter, referred to as AGC) voltage of the received signal that has been low-noise amplified by the LNA. For example, if the AGC voltage is smaller than a predetermined threshold value, the receiver decreases the gain of the LNA. On the other hand, if the AGC voltage is equal to or greater than the predetermined threshold value, the receiver increases the gain of the LNA.

When a received signal has a strong electric field, even if a receiver adequately changes the gain of an LNA according to the above-described rule, the LNA may be saturated. The saturation of the LNA causes the received signal to be distorted or discontinued. Thus, the receive sensitivity of the receiver is degraded.

### SUMMARY OF THE INVENTION

It is an aspect of the present general inventive concept to provide an apparatus that automatically controls the activation of a low noise amplifier of a receiver by using an automatic gain control (AGC) current for a received signal.

It is another aspect of the present general inventive concept to provide a method of automatically controlling the activation of a low noise amplifier of a receiver by using an automatic gain control (AGC) current for a received signal.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing an apparatus that controls a low noise amplifier of a receiver, the apparatus including an automatic gain control current detector that detects an automatic gain control current based on the level of a signal output from the low noise amplifier, a switch that controls the activation of the low noise amplifier, and a controller that controls the operation of the switch based on the automatic gain control current detected by the automatic gain control current detector.

The foregoing and/or other aspects of the present general inventive concept may also be achieved by providing an apparatus that controls a low noise amplifier of a receiver, the apparatus including a tuner that tunes the channel of a signal output from the low noise amplifier, an intermediate frequency converter that converts a channel-tuned signal output from the tuner into an intermediate frequency signal while detecting an automatic gain control current based on the level of the channel-tuned signal, a switch that controls the activation of the low noise amplifier, and a controller that controls the operation of the switch according to the automatic gain control current detected by the intermediate frequency converter.

The foregoing and/or other aspects of the present general inventive concept may also be achieved by providing an apparatus that controls a low noise amplifier of a receiver, the apparatus including a tuner that includes the low noise amplifier and a switch controlling activation of the low noise amplifier, an automatic gain control current detector that detects an automatic gain control current based on the level of a signal output from the tuner, and a controller that controls the operation of the switch, according to the automatic gain control current detected by the automatic gain control current detector.

The foregoing and/or other aspects of the present general inventive concept may also be achieved by providing a method of controlling a low noise amplifier of a receiver, the method including detecting an automatic gain control current based on the level of a signal output from the low noise amplifier, inactivating the low noise amplifier if the detected automatic gain control current is equal to or greater than a threshold value, and activating the low noise amplifier if the detected automatic gain control current is smaller than the threshold value.

The foregoing and/or other aspects of the present general inventive concept may also be achieved by providing a method of controlling a low noise amplifier of a receiver, which has a tuner including the low noise amplifier and a switch that controls the activation of the low noise amplifier, the method including detecting an automatic gain control current based on the level of a signal output from the tuner, controlling the switch so that the low noise amplifier is inactivated, if the detected automatic gain control current is equal to or greater than a threshold value, and controlling the switch so that the low noise amplifier is activated, if the detected automatic gain control current is smaller than the threshold value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a functional block diagram showing an apparatus that controls a low noise amplifier (LNA) of a receiver, according to and embodiment of the present general inventive concept; and

FIG. 2 is a flowchart illustrating a method of controlling an LNA of a receiver, according to another embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

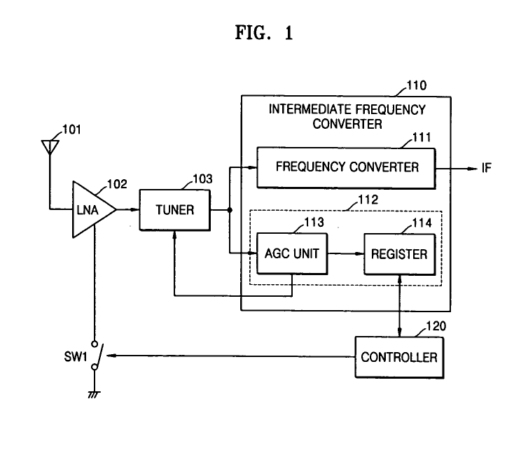

Referring to FIG. 1, an apparatus that controls a low noise amplifier (hereinafter, referred to as LNA) of a receiver, according to an embodiment of the present general inventive concept, includes an antenna 101, an LNA 102, a tuner 103, an intermediate frequency (IF) converter 110, a controller 120, and a switch SW1.

When a radio frequency (RF) signal is received via the antenna 101, the LNA 102 amplifies the received RF signal. More specifically, the LNA 102 removes noise from the received RF signal and amplifies the noise-free received RF signal. A low-noise amplified signal obtained by the LNA 102 can be applied to the tuner 103.

The tuner 103 performs channel tuning for the low-noise amplified signal. To do this, the tuner 103 may include an amplifier (not shown) that amplifies a received signal to a predetermined level, a bandpass filter (not shown) that passes only a signal in a desired reception band, and a phase lock loop (not shown) that provides a tuning voltage. A channel-tuned signal obtained by the tuner 103 can be applied to the IF converter 110.

The IF converter 110 can convert the channel-tuned signal into an IF signal while detecting an automatic gain control (AGC) current based on the level of the channel-tuned signal. To do this, the IF converter 110 can include a frequency converter 111 and an AGC current detector 112, as shown in FIG. 1.

The frequency converter 111 can convert an input signal into an IF signal. The AGC current detector 112 can include an AGC unit 113 that detects an AGC voltage and an AGC current based on the level of the input signal, and a register 114 that stores the AGC current detected by the AGC unit 113. The AGC voltage detected by the AGC unit 113 can be applied to the tuner 103. The tuner 103 uses the AGC voltage to control the amplification gain of a received signal.

When the receiver operates, the controller 120 can monitor the AGC current value stored in the register 114 of the IF converter 110. In other words, the controller 120 can read an AGC current value from the register 114 and compare the read AGC current value with a predetermined threshold value. The threshold value can be determined in consideration of an electric field that causes a saturation of the LNA 102, and an AGC current value corresponding to the electric field. If the read AGC current value is equal to or greater than the predetermined threshold value, the controller 120 turns on the switch SW1 so as to inactivate the LNA 102. On the other hand, if the read AGC current value is smaller than the predetermined threshold value, the controller 120 turns off the switch SW1 so as to activate the LNA 102.

Although the LNA 102 and the tuner 103 are separately installed from each other in FIG. 1, they may be combined into a tuner circuit. In this case, the switch SW1 can be included in the tuner circuit. Hence, if the LNA 102 and the tuner 103 are combined into a tuner circuit, the controller 120 can provide a switch (SW1) control signal generated by the monitoring of the AGC current value stored in the register 114, to the tuner circuit. Although the frequency converter 111 and the AGC current detector 112 are included in the IF converter 110 in FIG. 1, they may be installed separately from each other.

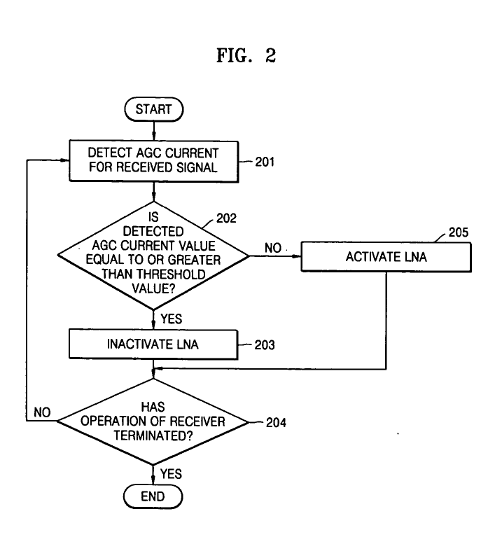

FIG. 2 is a flowchart illustrating a method of controlling an LNA of a receiver, according to another embodiment of the present general inventive concept, which can be applied to the apparatus of FIG. 1.

In operation 201 of FIG. 2, an AGC current for a received signal that has been low-noise amplified by the LNA 102 of FIG. 1 is detected. The low-noise amplified signal has been channel-tuned.

In operation 202, it is determined whether the detected AGC current value is equal to or greater than a predetermined threshold value. The threshold value is determined based on the description provided with reference to FIG. 1. If the detected AGC current is equal to or greater than the threshold value, the LNA 102 is inactivated in operation 203. To be more specific, the receiver turns the switch SW1 on so as to inactivate the LNA 102. Accordingly, the receiver uses a received signal that has not been low-noise amplified by the LNA 102.

In operation 204, it is determined whether the operation of the receiver has terminated. If it is determined in operation 204 that the operation of the receiver has not terminated, the method feeds back to operation 201, and the above-described process is repeated.

If it is determined in operation 202 that the detected AGC current is smaller than the threshold value, the LNA 102 is activated in operation 205. Accordingly, the receiver uses a received signal that has been low-noise amplified by the LNA 102. The operation 205 is followed by operation 204, and the above-described process is repeated.

Hence, the receiver controls the LNA 102 to be inactivated, and if the electric field of a received signal becomes low, the receiver can also control the LNA 102 to be activated. Even when the LNA 102 is inactivated, the receiver can monitor the AGC current of the received signal and can activate the LNA 102 according to the result of monitoring.

As described above, if the value of an AGC current for a received signal is equal to or greater than a threshold value, an LNA is inactivated. On the other hand, if the value of the AGC current for the received signal is smaller than the threshold value, the LNA is activated. Thus, an apparatus that controls an LNA of a receiver, according to an embodiment of the present general inventive concept, enables the receiver to keep a good receive sensitivity regardless of the electric field of a received signal.

Since a controller of the receiver controls the activation of the LNA, if the receiver includes a tuner circuit into which the LNA and a tuner are combined, a change in the hardware of a tuner circuit can be minimized. Thus, the costs of manufacturing the receiver can be reduced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus that controls a low noise amplifier of a receiver, the apparatus comprising:
an automatic gain control current detector detecting an automatic gain control current based on the level of a signal output from the low noise amplifier;
a switch that controls the activation of the low noise amplifier; and
a controller that controls the operation of the switch based on the automatic gain control current detected by the automatic gain control current detector.

2. The apparatus of claim 1, wherein if the automatic gain control current is equal to or greater than a threshold value, the controller controls the switch so that the low noise amplifier is inactivated, and if the automatic gain control current is smaller than the threshold value, the controller controls the switch so that the low noise amplifier is activated.

3. The apparatus of claim 1, further comprising a tuner which tunes the channel of the signal output from the low noise amplifier and provides the channel-tuned signal to the automatic gain control current detector.

4. An apparatus that controls a low noise amplifier of a receiver, the apparatus comprising:
a tuner that tunes a channel of a signal output from the low noise amplifier;
an intermediate frequency converter that converts a channel-tuned signal output from the tuner into an intermediate frequency signal while detecting an automatic gain control current based on the level of the channel-tuned signal;
a switch that control the activation of the low noise amplifier; and
a controller that controls the operation of the switch according to the automatic gain control current detected by the intermediate frequency converter.

5. The apparatus of claim 4, wherein the intermediate frequency converter comprises:
a frequency converter to convert an input signal into an intermediate frequency signal; and
an automatic gain control (AGC) current detector to detect the automatic gain control current.

6. The apparatus of claim 5, wherein the AGC current detector comprises:
an AGC unit that detects an AGC voltage and an AGC current based on the level of the input signal; and
a register that stores an AGC current detected by the AGC unit.

7. The apparatus of claim 6, wherein the controller monitors the AGC current value stored in the register by reading the AGC current value from the register and compares the read AGC current value with a predetermined threshold value.

8. The apparatus of claim 7, wherein the threshold value is determined based an electric field that causes a saturation of the LNA and an AGC current value corresponding to the electric field.

9. An apparatus that controls a low noise amplifier of a receiver, the apparatus comprising:
a tuner including the low noise amplifier and a switch that controls the activation of the low noise amplifier;
an automatic gain control current detector that detects an automatic gain control current based on the level of a signal output from the tuner; and
a controller that controls the operation of the switch, according to the automatic gain control current detected by the automatic gain control current detector.

10. A method of controlling a low noise amplifier of a receiver, the method comprising:
detecting an automatic gain control current based on the level of a signal output from the low noise amplifier;
inactivating the low noise amplifier if the detected automatic gain control current is equal to or greater than a threshold value; and
activating the low noise amplifier if the detected automatic gain control current is smaller than the threshold value.

11. A method of controlling a low noise amplifier of a receiver, which has a tuner including the low noise amplifier and a switch that controls the activation of the low noise amplifier, the method comprising:
detecting an automatic gain control current based on the level of a signal output from the tuner;
controlling the switch so that the low noise amplifier is inactivated if the detected automatic gain control current is equal to or greater than a threshold value; and
controlling the switch so that the low noise amplifier is activated if the detected automatic gain control current is smaller than the threshold value.

12. A method of controlling a low noise amplifier of a receiver, the method comprising:
detecting an automatic gain control current based on the level of a signal output from the low noise amplifier; and
controlling activation and inactivation of the low noise amplifier depending on the value of the detected automatic gain control current.

13. A computer readable medium performing a method of controlling a low noise amplifier of a receiver, the method comprising:
detecting an automatic gain control current based on the level of a signal output from the low noise amplifier; and
controlling activation and inactivation of the low noise amplifier depending on the value of the detected automatic gain control current.
